(19) United States
(12) Patent Application Publication
(10) Pub. No.: US 2010/0278226 A1
(43) Pub. Date: Nov. 4, 2010

(54) TRANSMISSION CIRCUIT, DIFFERENTIAL SIGNAL TRANSMISSION CIRCUIT, AND TEST APPARATUS

(75) Inventor: Eric Barr Kushnick, Santa Clara, CA (US)

Correspondence Address: Masao Yoshimura, 333 W. El Camino Real, Suite 380, Sunnyvale, CA, 94087, US

(73) Assignee: ADVANTEST CORPORATION, Tokyo (JP)

(21) Appl. No.: 12/769,641

(22) Filed: Apr. 28, 2010

Related U.S. Application Data
(60) Provisional application No. 61/175,363, filed on May 4, 2009.

(51) Int. Cl. H04L 27/26; H04B 17/00

(52) U.S. Cl. 375/224; 375/295

(57) ABSTRACT

Provided is a test apparatus, a differential signal transmission circuit, and a transmission circuit that transmits signals between an input terminal and an output terminal, comprising a first high frequency signal passing section that blocks a low frequency signal that has a frequency less than a predetermined reference frequency in a signal received from the input terminal, and transmits a high frequency signal that has a frequency greater than or equal to the predetermined reference frequency to the output terminal; an input-side low frequency signal passing section that passes the low frequency signal in the signal from the input terminal and attenuates the high frequency signal; an output-side low frequency signal passing section that transmits to the output terminal the low frequency signal passed by the input-side low frequency signal passing section and attenuates the high frequency signal from the first high frequency signal passing section; and a switching section that switches a connection between the input-side low frequency signal passing section and the output-side low frequency signal passing section.

### BACKGROUND

1. Technical Field

The present invention relates to a transmission circuit, a differential signal transmission circuit, and a test apparatus.

2. Related Art

A transmission circuit can be used to switch between a DC coupling for transmitting a signal that includes a DC component and an AC coupling for transmitting a signal with an AC component from which the DC component and a low frequency component are removed. For example, the transmission circuit may switch between a transmission path that transmits a component including the DC component and a transmission path that transmits a high frequency component. For example, please see Patent Document 1.

Patent Document 1: Japanese Patent Application Publication No. 6-207953.

In a transmission circuit that switches between a transmission path that transmits a component including the DC component and a transmission path that transmits a high frequency component, the transmission bandwidth of the switch is set to be equal to the bandwidth of the signal being transmitted and the effect of reflection in the switch is considered. Furthermore, in the transmission path transmitting the high frequency component, the wire that branches to the low frequency component transmission path or the switch is a stub, thereby causing reflection that has a detrimental effect on the high frequency transmission.

### SUMMARY

Therefore, it is an object of an aspect of the innovations herein to provide a transmission circuit, a differential signal transmission circuit, and a test apparatus, which are capable of overcoming the above drawbacks accompanying the related art. The above and other objects can be achieved by combinations described in the independent claims. The dependent claims define further advantageous and exemplary combinations of the innovations herein.

According to a first aspect related to the innovations herein, one exemplary transmission circuit may include a transmission circuit that transmits signals between an input terminal and an output terminal, comprising: a first high frequency signal passing section that blocks a low frequency signal that has a frequency less than a predetermined reference frequency in a signal received from the input terminal, and transmits a high frequency signal that has a frequency greater than or equal to the predetermined reference frequency to the output terminal; an input-side low frequency signal passing section that passes the low frequency signal in the signal from the input terminal, that may attenuate the high frequency signal, and that isolates the high frequency signal from the input terminal; an output-side low frequency signal passing section that transmits to the output terminal the low frequency signal passed by the input-side low frequency signal passing section that may attenuate the high frequency signal from the high frequency signal passing section, and that isolates the high frequency signal from the output terminal; and a switching section that switches a connection between the input-side low frequency signal passing section and the output-side low frequency signal passing section.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows a configuration of a transmission circuit 100 according to an embodiment of the present invention.

FIG. 2 shows a configuration of a differential signal transmission circuit 200 according to an embodiment of the present invention, along with a differential signal source 210.

FIG. 3 shows exemplary results of signal transmission by the differential signal transmission circuit 200 according to the present embodiment.

FIG. 4 shows exemplary results of signal transmission by the differential signal transmission circuit 200 according to the present embodiment.

FIG. 5 shows a first modification of the differential signal transmission circuit 200 according to the present embodiment.

FIG. 6 shows a second modification of the differential signal transmission circuit 200 according to the present embodiment.

FIG. 7 shows a third modification of the differential signal transmission circuit 200 according to the present embodiment.

FIG. 8 shows a fourth modification of the differential signal transmission circuit 200 according to the present embodiment.

FIG. 9 shows a fifth modification of the differential signal transmission circuit 200 according to the present embodiment.

FIG. 10 shows an exemplary configuration of a test apparatus 1000 according to an embodiment of the present invention, along with a device under test 10.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

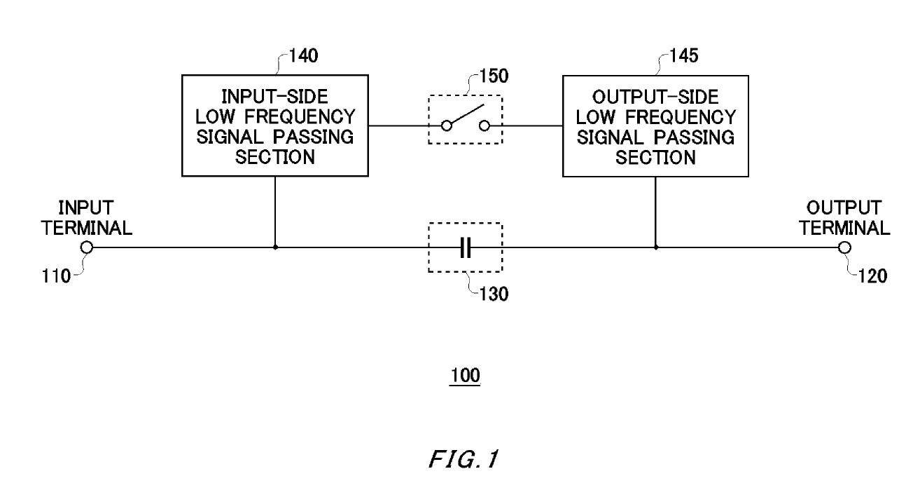

FIG. 1 shows a configuration of a transmission circuit 100 according to an embodiment of the present invention. The transmission circuit 100 transmits signals between an input terminal 110 and an output terminal 120. The transmission circuit 100 transmits a broadband signal including a signal that is tens of GHz from a DC signal. The transmission circuit 100 includes the input terminal 110, the output terminal 120, a first high frequency signal passing section 130, an input-side low frequency signal passing section 140, an output-side low frequency signal passing section 145, and a switching section 150.

The input terminal 110 receives the broadband signal including the DC component. The output terminal 120 outputs the broad band signal including the DC component or a high frequency signal whose frequency is greater than or equal to a prescribed value. The input terminal 110 and the output terminal 120 may be virtual terminals that correspond to junction points or branch points between a high frequency transmission path including the first high frequency signal passing section 130 and a low frequency transmission path including the input-side low frequency signal passing section 140, the output-side low frequency signal passing section 145, and the switching section 150. The output terminal 120 may be connected to one end of a termination resistor whose other end is connected to a reference voltage.

The input terminal 110 and the output terminal 120 may be coaxial connectors corresponding to the signal bandwidth being transmitted. For example, the input terminal 110 and the output terminal 120 may use a standardized connector such as N connectors, BNC connectors, SMA connectors, APC 3.5 connectors, K connectors, and APC 2.4 connectors. Instead, the input terminal 110 and the output terminal 120 may be fixed directly to the circuit substrate without a connecter therebetween, using soldering or the like.

The first high frequency signal passing section 130 blocks a low frequency signal that is a portion of the signal from the input terminal 110 having a frequency below a predetermined reference frequency, and transmits a resulting high frequency signal whose frequency is greater than or equal to the reference frequency to the output terminal 120. The first high frequency signal passing section 130 may be an AC coupling circuit in which capacitance elements are connected serially in the transmission path. Instead, the first high frequency signal passing section 130 may be a high-pass filter circuit. The reference frequency of the first high frequency signal passing section 130 is determined according to the elements in the circuit.

The input-side low frequency signal passing section 140 passes the low frequency signal in the signal from the input terminal 110 and attenuates the high frequency signal. The input-side low frequency signal passing section 140 may be an isolator circuit having one or more inductance elements arranged serially in the transmission path. These inductance elements may be made of ferrite. Instead, the input-side low frequency signal passing section 140 may be a resistance element provided serially in the transmission path. The input-side low frequency signal passing section 140 attenuates the high frequency signal, and can therefore attenuate the component reflected in the direction of the input terminal 110 when the high frequency signal is input.

The output-side low frequency signal passing section 145 transmits the low frequency signal that passed through the input-side low frequency signal passing section 140 to the output terminal 120, and attenuates the high frequency signal from the first high frequency signal passing section 130. The output-side low frequency signal passing section 145 may be the same type of isolator as the input-side low frequency signal passing section 140. The output-side low frequency signal passing section 145 attenuates the high frequency signal, and so the reflected signal from the circuit connected to the output terminal 120 is also attenuated. The output-side low frequency signal passing section 145 may be a resistance element that terminates the high frequency signal.

The switching section 150 switches whether there is a connection between the input-side low frequency signal passing section 140 and the output-side low frequency signal passing section 145. The switching section 150 may be a FET switch, a relay switch, a photocoupler, an optical MOS switch, or a MEMS switch. Instead, the switching section 150 may use an amplifier and select whether amplification is performed.

The switching section 150 turns the connection ON when the transmission circuit 100 passes the low frequency signal and turns the connection OFF when the transmission circuit 100 does not pass the low frequency signal, thereby switching the transmission bandwidth of the transmission circuit 100. The switching section 150 switches the passage of the low frequency signal but does not need to transmit the high frequency signal, and can therefore have a bandwidth corresponding to the low frequency signal.

The transmission circuit 100 of the present embodiment transmits to the output terminal 120 a high frequency signal, which is part of the signal input to the input terminal 110, with a frequency greater than or equal to a reference frequency determined according to the circuit elements of the first high frequency signal passing section 130. When the transmission circuit 100 uses the AC coupling that does not pass the low frequency signal with a frequency that is less than the reference frequency and including a DC signal, the switching section 150 is turned OFF. Here, the transmission circuit 100 attenuates the high frequency signal using the input-side low frequency signal passing section 140 and the output-side low frequency signal passing section 145 such that the high frequency signal is not transmitted in the transmission path that transmits the low frequency signal, and so the high frequency signal can be transmitted without being affected by reflection or the like.

When the transmission circuit 100 uses the DC coupling that passes the low frequency signal with a frequency that is less than the reference frequency and including a DC signal, the switching section 150 is turned ON. Here, the transmission circuit 100 attenuates the high frequency signal using the input-side low frequency signal passing section 140 and the output-side low frequency signal passing section 145 such that the high frequency signal is not transmitted by the switching section 150, and so the switching section 150 does not reflect the high frequency signal. In other words, the transmission circuit 100 uses an inexpensive switch as the switching section 150 for switching the transmission of the low frequency signal whose frequency is less than the reference frequency, and can switch the transmission of the low frequency signal without being affected by reflection or the like.

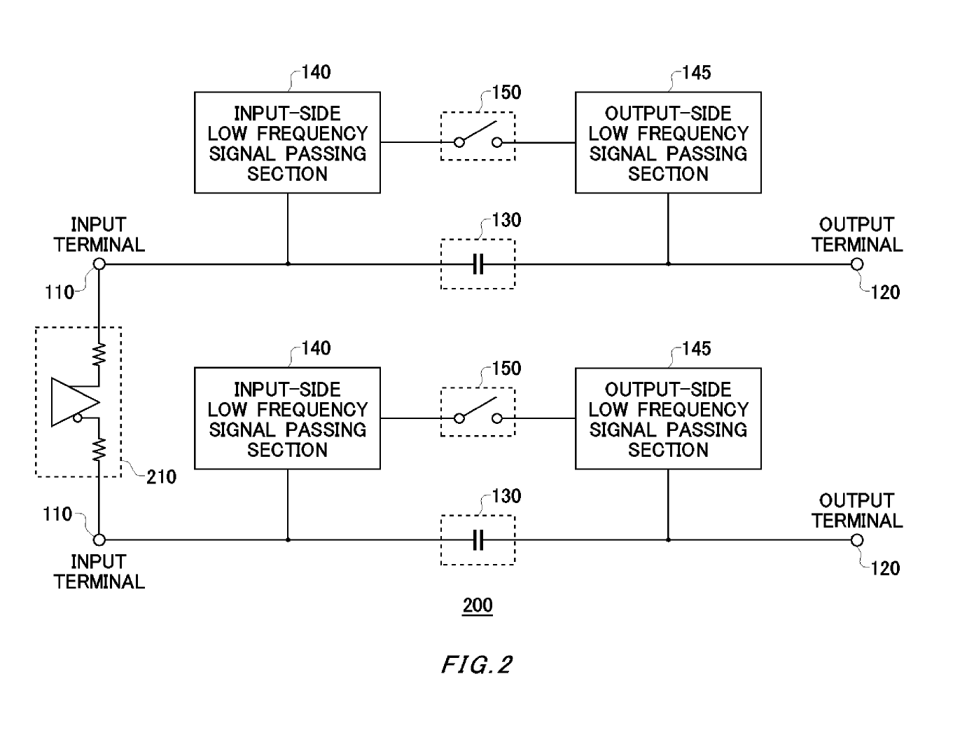

FIG. 2 shows a configuration of a differential signal transmission circuit 200 according to an embodiment of the present invention, along with a differential signal source 210. In the differential signal transmission circuit 200 of the present embodiment, components that are the same as those shown in the transmission circuit 100 of FIG. 1 are given the same reference numerals and redundant descriptions are omitted. The differential signal transmission circuit 200 transmits a differential signal between the input terminal 110 and the output terminal 120. The differential signal source 210 is an example of an apparatus that generates a signal having two polarities with inverted phases from each other on two transmission paths, and may be an apparatus or circuit that generates a differential signal.

The differential signal transmission circuit 200 includes (i) a transmission circuit 100 according to the above embodiment for transmitting a signal with a first polarity, which is one of the positive and negative component of the differential signal and (ii) a transmission circuit 100 according to the above embodiment for transmitting a signal with a second polarity, which is the other of the positive and negative component of the differential signal. The differential signal transmission circuit 200 transmits to respective output terminals 120 high frequency signals whose frequencies are greater than or equal to the reference frequency and that are included in a differential signal input to the input terminals 110.

When the differential signal transmission circuit 200 uses the AC coupling that does not pass the low frequency signal with a frequency that is less than the reference frequency and including the DC signal, the two switching sections 150 are turned OFF. The differential signal transmission circuit 200 uses two of the transmission circuits 100 according to the embodiment described above to transmit the differential signal, and can therefore transmit the differential signal without being affected by reflection or the like.

When the differential signal transmission circuit 200 uses the DC coupling that passes the low frequency signal with a frequency that is less than the reference frequency and including the DC signal, the two switching sections 150 are turned ON. Here, the differential signal transmission circuit 200 attenuates the high frequency signals using the input-side low frequency signal passing sections 140 and the output-side low frequency signal passing sections 145 such that the high frequency signals are not transmitted by the switching sections 150, and so the switching sections 150 do not reflect the high frequency signals. In other words, the differential signal transmission circuit 200 uses inexpensive switches as the switching sections 150 for switching the transmission of the low frequency signals whose frequencies are less than the reference frequency, and can switch the transmission of the low frequency differential signals without being affected by reflection or the like.

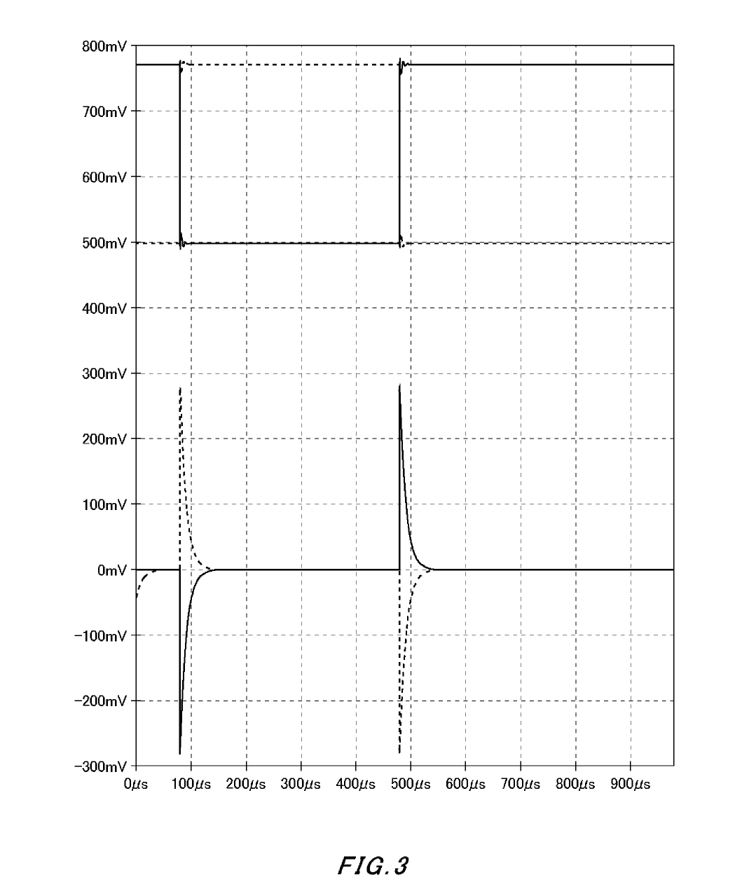

FIG. 3 shows exemplary results of signal transmission by the differential signal transmission circuit 200 according to the present embodiment. The upper portion of FIG. 3 shows results obtained when the two switching sections 150 of the differential signal transmission circuit 200 are turned ON and the low frequency and high frequency signals of the differential signal input thereto are transmitted. Two rectangular pulse waveforms with inverse phases were measured, and the resulting waveforms represented by the solid and dotted lines indicate that the differential signal transmission circuit 200 transmitted a differential signal having a common voltage greater than or equal to 600 mV.

The lower portion of FIG. 3 shows results obtained when the two switching sections 150 of the differential signal transmission circuit 200 are turned OFF and the high frequency signal of the differential signal input thereto is transmitted. A differential waveform, centered on 0 V, corresponding to the rising edges and falling edges of a rectangular pulse was measured, and the resulting waveforms represented by the solid and dotted lines indicate that the differential signal transmission circuit 200 transmitted the high frequency component of the differential signal.

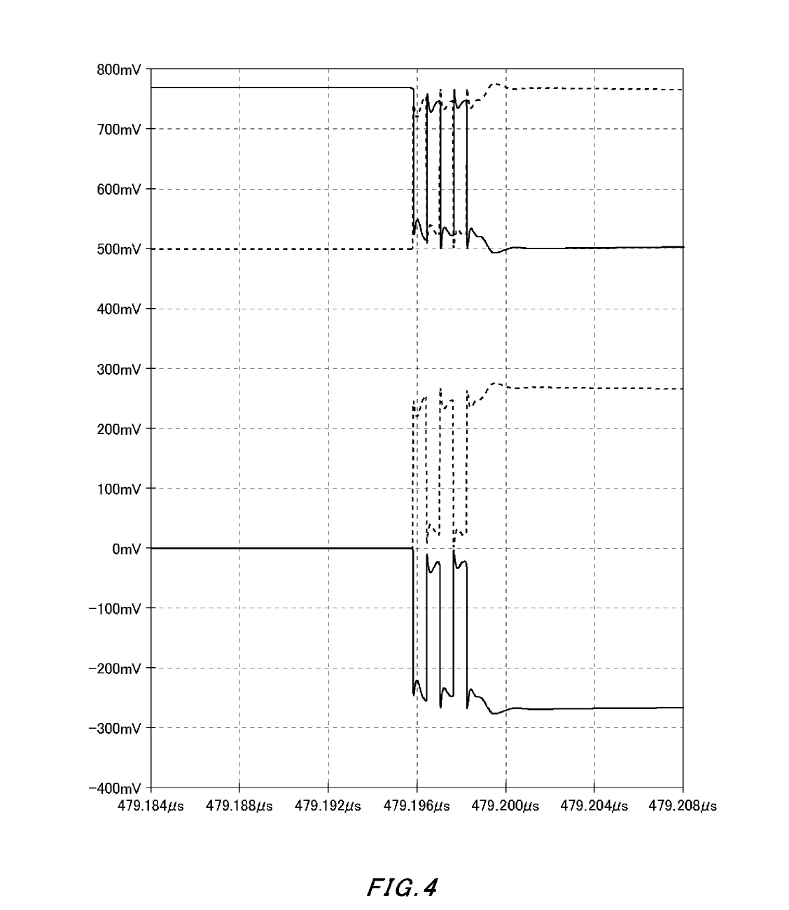

FIG. 4 shows exemplary results of signal transmission by the differential signal transmission circuit 200 according to the present embodiment. The graph in FIG. 4 has a time axis with a smaller range than in FIG. 3, in order to more accurately show the rising and falling waveform of the pulse. The upper portion of FIG. 4 shows results obtained when the two switching sections 150 of the differential signal transmission circuit 200 are turned ON and the low frequency and high frequency signals of the differential signal input thereto are transmitted. Two pulse waveforms with inverse phases were measured, and the resulting waveforms represented by the solid and dotted lines indicate that the differential signal transmission circuit 200 transmitted a differential signal having a common voltage greater than or equal to 600 mV.

The lower portion of FIG. 4 shows results obtained when the two switching sections 150 of the differential signal transmission circuit 200 are turned OFF and the high frequency signal of the differential signal input thereto is transmitted. A differential waveform corresponding to the rising and falling of a pulse was measured, and the resulting waveforms represented by the solid and dotted lines indicate that the differential signal transmission circuit 200 transmitted the high frequency component of the differential signal. Based on these observed results, it is understood that the differential signal transmission circuit 200 can switch to transmit the low frequency signal without affecting transmission of the high frequency signal.

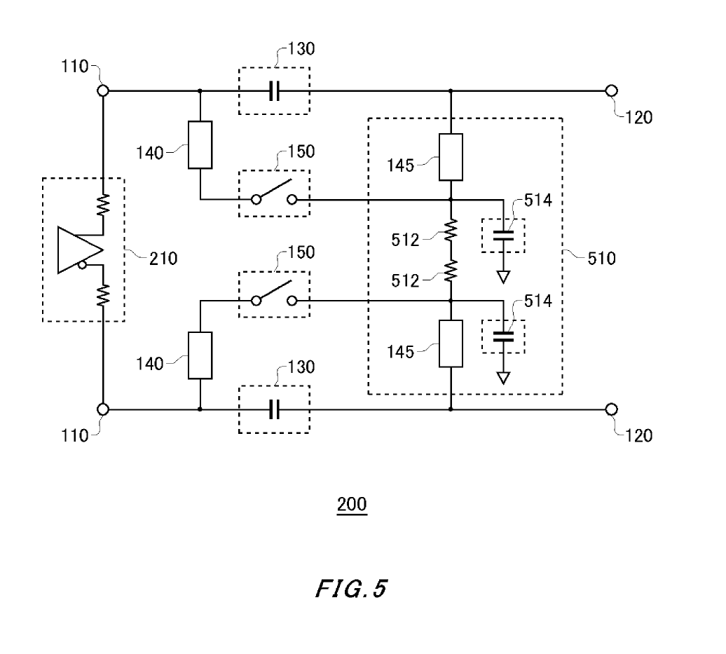

FIG. 5 shows a first modification of the differential signal transmission circuit 200 according to the present embodiment. In the differential signal transmission circuit 200 of the present modification, components that are the same as those shown in the differential signal transmission circuit 200 of FIG. 2 are given the same reference numerals and redundant descriptions are omitted. The differential signal transmission circuit 200 of the present modification further includes a termination network 510.

The termination network 510 terminates the transmission path that transmits the low frequency signal and the transmission path that transmits the high frequency signal. The output-side low frequency signal passing section 145 may be a termination resistance which terminates the transmission path that transmits the high frequency signal. The termination network 510 may include a second high frequency signal passing section 514 between each low frequency signal transmission path and the standard voltage. The termination network 510 may include two resistance elements connected between the transmission paths that transmit the low frequency signals. The second high frequency signal passing sections 514 may include capacitance elements. Here, the standard voltage may be a ground potential.

The second high frequency signal passing sections 514 present a low impedance to the high frequency signal and a high impedance to the DC and low frequency signal. In the termination network 510, the output-side low frequency signal passing sections 145 connected to output terminals 120 act as termination resistances for the transmission paths of the high frequency signals. The second high frequency signal passing sections 514 pass the high frequency signal termination current to the ground potential, but block the passage of DC and low frequency signals.

When the two switching sections 150 are turned ON, the DC and low frequency components input from the input terminals 110 are applied to the output-side low frequency signal passing sections 145, which are the high frequency signal path termination resistances, and are transmitted to the output terminals 120. Accordingly, the differential signal transmission circuit 200 transmits the DC, low frequency, and high frequency components to the output terminals 120. When the two switching sections 150 are turned OFF, the differential signal transmission circuit 200 transmits only the high frequency component to output terminal 120.

The two resistance elements 512 may respectively terminate the DC and low frequency signals transmitted on the two low frequency signal transmission paths. Instead, the junction of the two resistance elements 512 may be connected to a standard voltage. The present embodiment describes a circuit transmitting a differential signal, but a single-ended version of this circuit, in which one transmission path from input terminal 110 to output terminal 120 is used, is also possible.

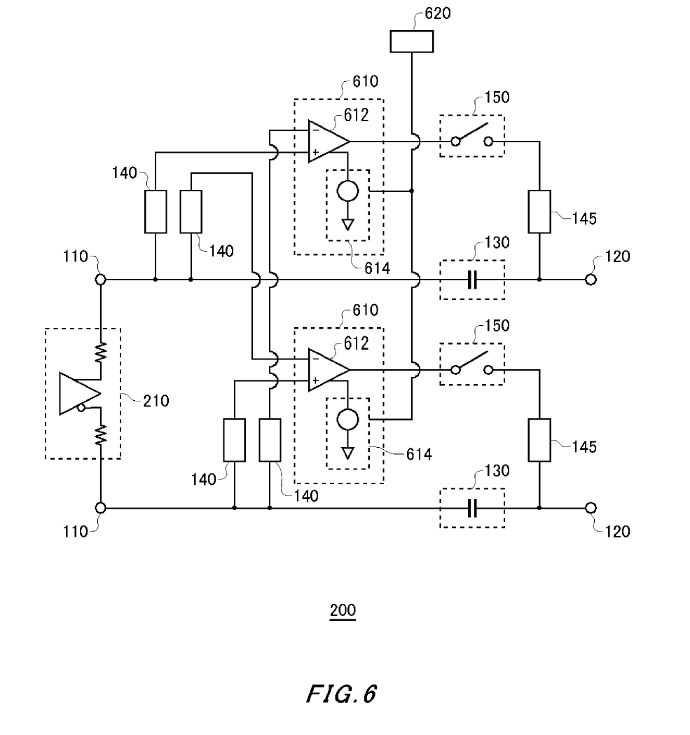

FIG. 6 shows a second modification of the differential signal transmission circuit 200 according to the present embodiment. In the differential signal transmission circuit 200 of the present modification, components that are the same as those shown in the differential signal transmission circuit 200 of FIG. 2 are given the same reference numerals and redundant descriptions are omitted. The differential signal transmission circuit 200 of the present modification further includes amplifying sections 610 and a reference voltage changing section 620.

The amplifying sections 610 are provided respectively to the first and second transmission circuits, and amplify the signals from the input-side low frequency signal passing sections 140. Each amplifying section 610 may include a differential amplifier circuit 612 and a reference voltage section 614. The differential amplifier circuits 612 each output a difference between the two signals output by the input-side low frequency signal passing sections 140 in the first and second transmission circuits. The reference voltage sections 614 each output a predetermined voltage. The reference voltage sections 614 may output voltages serving as the common voltage of the differential signal. One of the reference voltage sections 614 may be connected to each of the two differential amplifier circuits 612 in the first and second transmission circuits.

The reference voltage changing section 620 can change the output voltages of the reference voltage sections. The reference voltage changing section 620 may cause the reference voltage sections 614 in the first and second transmission paths to each output different voltages. The amplifying sections 610 each output a signal corresponding to a predetermined reference voltage and a signal input thereto. Instead, the reference voltage changing section 620 may modulate the reference voltage sections with a prescribed modulating signal.

Each amplifying section 610 can amplify the low frequency signal, according to the reference voltage and the signal input thereto, in the low frequency transmission path in which the high frequency signal is attenuated. When the two switching sections 150 are ON, the differential signal transmission circuit 200 superimposes an offset voltage onto the signal input from the input terminal 110, and outputs the resulting signal from the output terminal 120. Furthermore, when the two switching sections 150 are OFF, the differential signal transmission circuit 200 transmits only the high frequency signal.

The differential signal transmission circuit 200 may omit the switching sections 150 and instead use switching of the amplification of the amplifying sections 610 or the like. If the switching sections 150 are to be constantly turned ON, the differential signal transmission circuit 200 need not include the switching sections 150. The present embodiment describes a circuit transmitting a differential signal, but a single-ended version of this circuit, in which one transmission path is used, is also possible.

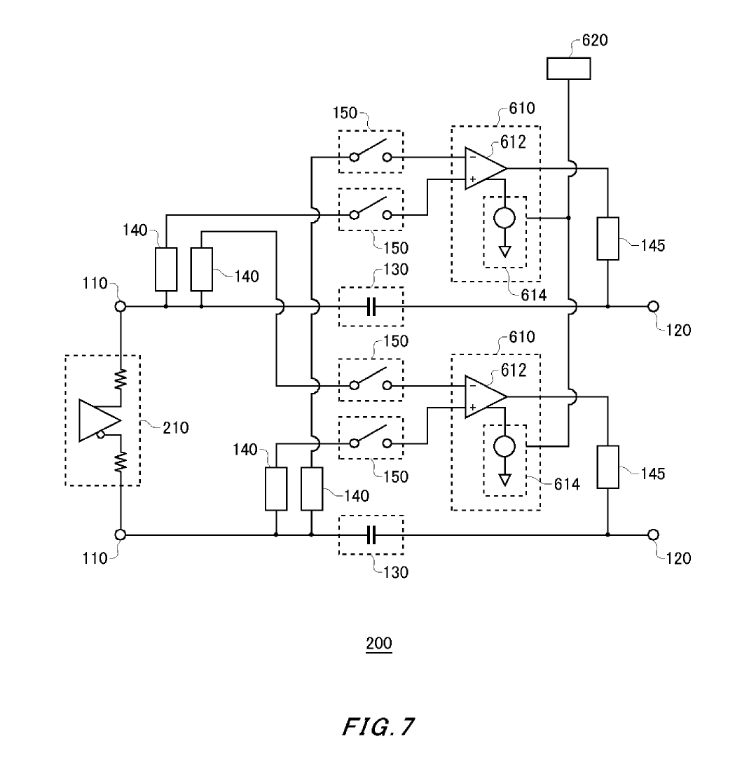

FIG. 7 shows a third modification of the differential signal transmission circuit 200 according to the present embodiment. In the differential signal transmission circuit 200 of the present modification, components that are the same as those shown in the differential signal transmission circuit 200 of FIG. 6 are given the same reference numerals and redundant descriptions are omitted. In the differential signal transmission circuit 200 of the present modification, the positioning of the switching sections 150 has been moved from downstream of the amplifying sections 610 to upstream of the amplifying sections 610.

As a result, when transmission of the low frequency signals is turned OFF, the input of signals to the amplifying sections 610 is completely OFF. Furthermore, by forming the output-side low frequency signal passing section 145 as a circuit in which resistance elements and inductance elements are connected serially, the amplifying sections 610 and the output-side low frequency signal passing section 145 can serve as a bias T circuit.

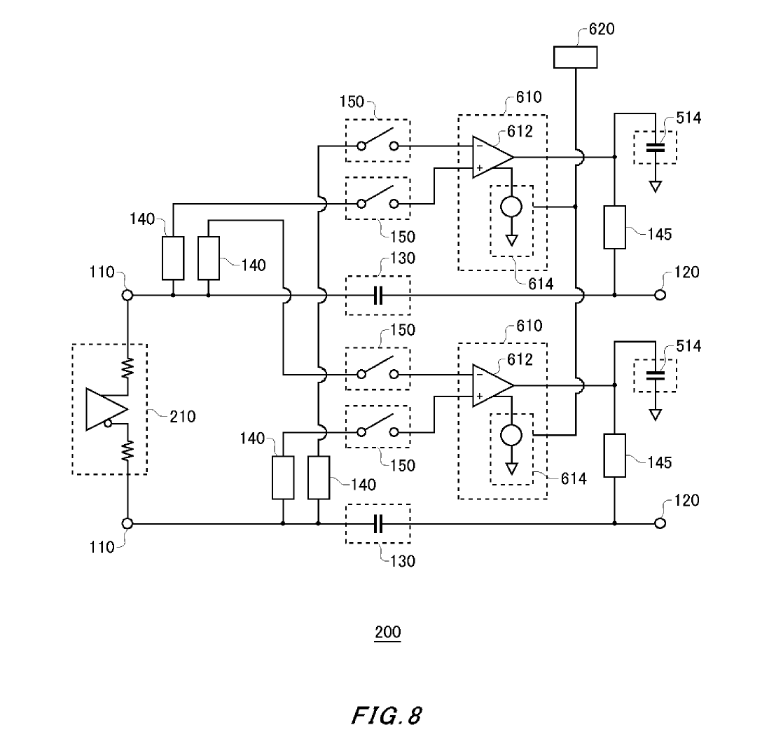

FIG. 8 shows a fourth modification of the differential signal transmission circuit 200 according to the present embodiment. In the differential signal transmission circuit 200 of the present modification, components that are the same as those shown in the differential signal transmission circuit 200 of FIG. 5 or FIG. 7 are given the same reference numerals and redundant descriptions are omitted. The differential signal transmission circuit 200 of the present modification further includes second high frequency signal passing sections 514.

The output-side low frequency signal passing section 145 may be a termination resistance that terminates the transmission path that transmits the high frequency signal. A second high frequency signal passing section 514 may be positioned between at least one of the low frequency signal transmission paths and the standard voltage. The second high frequency signal passing section 514 may be a capacitance element. Here, the standard voltage may be a ground potential. The second high frequency signal passing sections 514 present a low impedance to the high frequency signal and a high impedance to the DC and low frequency signal. In the differential signal transmission circuit 200, the output-side low frequency signal passing sections 145 act as termination resistances for the transmission paths of the high frequency signals. As a result, by turning the switching sections 150 ON, the differential signal transmission circuit 200 superimposes an amplified signal of the difference between the low frequency signals input from the two input terminals 110 onto the signal input from the input terminals 110, and outputs the resulting signal from the output terminals 120. The present embodiment describes a circuit that transmits a differential signal, but a single-ended transmission path, in which there is one group of high frequency and low frequency transmission paths from the input terminals 110 to the output terminals 120, may be used.

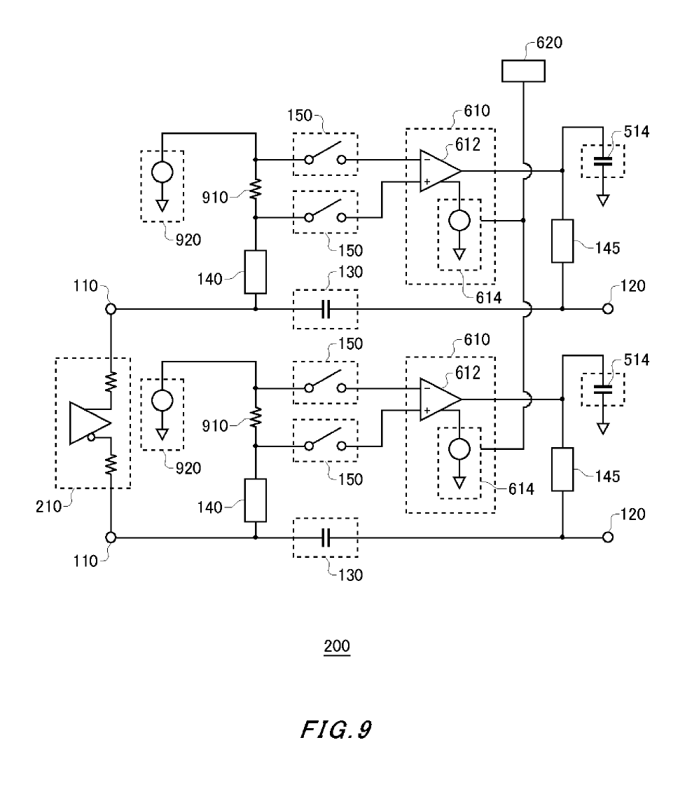

FIG. 9 shows a fifth modification of the differential signal transmission circuit 200 according to the present embodiment. In the differential signal transmission circuit 200 of the present modification, components that are the same as those shown in the differential signal transmission circuit 200 of FIG. 8 are given the same reference numerals and redundant descriptions are omitted. The differential signal transmission circuit 200 of the present modification further includes a resistance element 910 and a reference voltage section 920 in each of the transmission paths.

One of the resistance elements 910 is provided between one of the reference voltage sections 920 and an output end of the input-side low frequency signal passing section 140 of the first transmission path. The amplifying section 610 of the first transmission path receives as input the output of the input-side low frequency signal passing section 140 and the reference voltage of the reference voltage section 920 of the first transmission path.

In the second transmission path, one of the resistance elements 910 is provided between one of the reference voltage sections 920 and an output end of the input-side low frequency signal passing section 140 of the second transmission path, in the same manner. The amplifying section 610 of the second transmission path receives as input the output of the input-side low frequency signal passing section 140 and the reference voltage of the reference voltage section 920 of the second transmission path. Reference voltage section 920 combined with resistance element 910 and the input-side low frequency signal passing section 140, may act as a bias-T for the input terminal 110 while providing the DC and low frequency signals to drive amplifying section 610. Single-ended versions of this circuit are also possible.

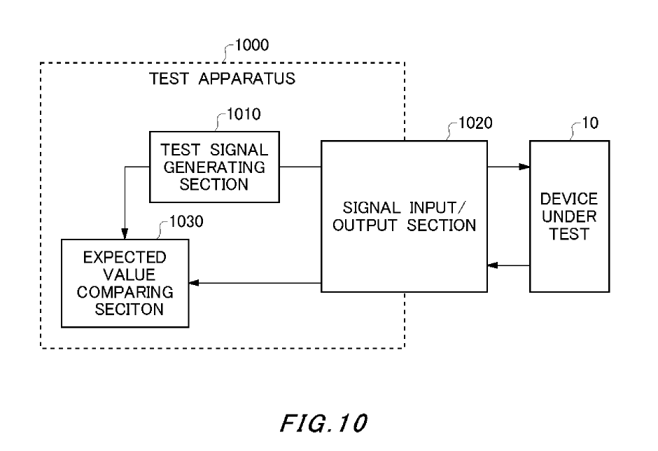

FIG. 10 shows an exemplary configuration of a test apparatus 1000 according to an embodiment of the present invention, along with a device under test 10. The test apparatus 1000 tests at least one device under test 10, which may be an analog circuit, a digital circuit, a mixed analog/digital circuit, a memory, a system on chip (SOC), or the like. The test apparatus 1000 supplies the device under test 10 with a test signal based on a test pattern for testing the device under test 10, and judges acceptability of the device under test 10 based on a signal output by the device under test 10 in response to the test signal.

The test apparatus 1000 includes a test signal generating section 1010, a signal input/output section 1020, and an expected value comparing section 1030. The test signal generating section 1010 generates a plurality of test signals to supply to the device under test 10. The test signal generating section 1010 may generate an expected value for a response signal output from the device under test 10 in response to the test signals. The test signal generating section 1010 may be connected to a plurality of devices under test 10 via the signal input/output section 1020 to test the plurality of devices under test 10.

The signal input/output section 1020 is connected to one or more devices under test 10, and exchanges test signals between the test apparatus 1000 and the device under test 10. The signal input/output section 1020 may be a performance board onto which a plurality of devices under test 10 are loaded.

The expected value comparing section 1030 compares received data from the signal input/output section 1020 to the expected value. The expected value comparing section 1030 may receive the expected value from the test signal generating section 1010. The test apparatus 1000 judges the acceptability of the device under test 10 based on the comparison result of the expected value comparing section 1030.

The test apparatus 1000 may use single end signal transmission to transmit the signals between the signal input/output section 1020 and the device under test 10. The test apparatus 1000 may use the transmission circuit 100 according to an embodiment of the present invention to perform the single end signal transmission. In this way, the test apparatus 1000 can switch between AC coupling and DC coupling for single end signal transmission. Furthermore, the test apparatus 1000 can switch whether the offset voltage is superimposed.

Instead, the test apparatus 1000 may use differential signal transmission to transmit the signals between the signal input/output section 1020 and the device under test 10. The test apparatus 1000 may use the differential signal transmission circuit 200 according to an embodiment of the present invention to perform the differential signal transmission. In this way, the test apparatus 1000 can switch between AC coupling and DC coupling for differential signal transmission. The test apparatus 1000 can switch whether the offset voltage is superimposed.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A transmission circuit that transmits signals between an input terminal and an output terminal, comprising:
a first high frequency signal passing section that blocks a low frequency signal that has a frequency less than a predetermined reference frequency in a signal received from the input terminal, and transmits a high frequency signal that has a frequency greater than or equal to the predetermined reference frequency to the output terminal;
an input-side low frequency signal passing section that passes the low frequency signal in the signal from the input terminal and attenuates or isolates the high frequency signal;
an output-side low frequency signal passing section that transmits to the output terminal the low frequency signal passed by the input-side low frequency signal passing section and attenuates or isolates the high frequency signal from the first high frequency signal passing section; and
a switching section that switches a connection between the input-side low frequency signal passing section and the output-side low frequency signal passing section.

2. The transmission circuit according to claim 1, comprising an amplifying section that is connected between the input-side low frequency signal passing section and the output-side low frequency signal passing section, amplifies the signal from the input-side low frequency signal passing section, and outputs the amplified signal.

3. The transmission circuit according to claim 2 wherein
the output-side low frequency signal passing section includes a second high frequency signal passing section that has one end thereof connected to a transmission path that transmits the low frequency signal and the other end thereof connected to a standard voltage, and that passes the high frequency signal to a standard voltage side.

4. The transmission circuit according to claim 2, wherein
the amplifying section outputs a signal corresponding to a preset reference voltage and a signal input thereto.

5. The transmission circuit according to claim 4, further comprising a reference voltage changing section that changes the reference voltage.

6. The transmission circuit according to claim 5, wherein
the reference voltage changing section changes the reference voltage over time.

7. The transmission circuit according to claim 1, further comprising a termination network that includes the output-side low frequency signal passing section and terminates the high frequency signal and the low frequency signal.

8. The transmission circuit according to claim 1, wherein
the output-side low frequency signal passing section includes a second high frequency signal passing section that has one end thereof connected to a transmission path that transmits the low frequency signal and the other end thereof connected to a standard voltage, and that passes the high frequency signal to a standard voltage side.

9. The transmission circuit according to claim 1, wherein
at least one of the input-side low frequency signal passing section and the output-side low frequency signal passing section includes at least one inductance element provided serially in a transmission path thereof.

10. A differential signal transmission circuit that transmits differential signals between an input terminal and an output terminal, comprising:
a first transmission circuit according to claim 1 for transmitting a signal with a first polarity of the differential signal; and
a second transmission circuit according to claim 1 for transmitting a signal with a second polarity of the differential signal.

11. The differential signal transmission circuit according to claim 10, further comprising a termination network that includes the output-side low frequency signal passing section and terminates a high frequency signal and a low frequency signal of the differential signal.

12. The differential signal transmission circuit according to claim 10, wherein
the first and second transmission circuits each include an amplifying section that amplifies a signal from the input-side low frequency signal passing section and outputs the amplified signal.

13. The differential signal transmission circuit according to claim 12, wherein
the amplifying sections in the first and second transmission circuits each include a differential amplifier circuit that outputs a difference between two signals output by the input-side low frequency signal passing section in the corresponding transmission circuit.

14. The differential signal transmission circuit according to claim 12, wherein
the amplifying sections in the first and second transmission circuits each output a signal corresponding to a preset reference voltage and a signal input thereto.

15. The differential signal transmission circuit according to claim 14, further comprising a reference voltage changing section that changes the reference voltages.

16. The transmission circuit according to claim 15, wherein
the reference voltage changing section changes the reference voltage over time.

17. The differential signal transmission circuit according to claim 10, wherein
at least one of the first transmission circuit and the second transmission circuit includes a second high frequency signal passing section that has one end thereof connected to a transmission path that transmits the low frequency signal and the other end thereof connected to a standard voltage, and that passes the high frequency signal to a standard voltage side.

18. The differential signal transmission circuit according to claim 12, wherein
at least one of the first transmission circuit and the second transmission circuit includes a second high frequency signal passing section that has one end thereof connected to a transmission path that transmits the low frequency signal and the other end thereof connected to a standard voltage, and that passes the high frequency signal to a standard voltage side.

19. The differential signal transmission circuit according to claim 10, wherein
at least one of the input-side low frequency signal passing sections and the output-side low frequency signal passing sections in the first and second transmission circuits includes at least one inductance element provided serially in a transmission path.

20. The differential signal transmission circuit according to claim 19, wherein
the inductance element is made of ferrite.

21. A test apparatus that tests a device under test, comprising:
a test signal generating section that generates a plurality of test signals to be supplied to the device under test; and
a signal input/output section that sends and receives signals to and from the device under test, wherein
the test apparatus transmits signals between the signal input/output section and the device under test using the transmission circuit according to claim 1.
